(19) United States
(12) Patent Application Publication
(10) Pub. No.: US 2008/0009580 A1
(43) Pub. Date: Jan. 10, 2008

(54) Resin Composition For Fuel Cell Member And Fuel Cell Member

(75) Inventors: Sueki Sugawara, Chiba (JP); Toshiyuki Ishii, Chiba (JP); Kazuyuki Iida, Chiba (JP); Hidenori Ichikawa, Shizuoka (JP); Hiroyuki Muramatsu, Shizuoka (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Tokyo Roki Mfg Co., Ltd, Shizuoka (JP)

(21) Appl. No.: 11/791,490

(22) PCT Filed: Oct. 6, 2006
(86) PCT No.: PCT/JP06/20105

§ 371 Date: May 24, 2007

(30) Foreign Application Priority Data
Oct. 7, 2005 (JP) 2005-294980

(51) Int. Cl. C08K 3/04; C08L 23/10

(52) U.S. Cl. 524/496; 524/584

(57) ABSTRACT

A fuel cell member-forming resin composition including (1) 67 to 89 wt % of a polypropylene-based resin, (2) 1 to 3 wt % of an acid-modified polypropylene-based resin, and (3) 10 to 30 wt % of carbon fibers and a high-purity ultrathin graphite powder having an ash content of less than 0.5 wt %.

### TECHNICAL FIELD

The invention relates to a fuel cell member-forming resin composition and a fuel cell member formed of the composition.

### BACKGROUND ART

As a material for fuel cells or secondary battery systems, 316SS stainless steel, which is considered to be a metal material exhibiting minimum dissolution of ions, has been used to maintain cooling efficiency and prevent blocking or corrosion of pipes. In automotive fuel cells, a material exhibiting extremely low dissolution of ions (e.g. 316SS) has been used as the material for heat exchangers or coolant circulating pipes.

However, the stainless steel material poses limitations on the shape of the heat exchanger, production method, and the like, thereby increasing the size, weight, cost, and the like of the heat exchanger.

Moreover, metal ions may be gradually dissolved when using the metal material, whereby corrosion may progress from small scratches on the surface. A method has been proposed which prevents corrosion by coating the inner surface of a heat exchanger or the like to reduce dissolution of ions. However, ions may be dissolved when the coating has deteriorated (e.g. patent documents 1 and 2).

In view of the above problems, a resin material has been demanded which replaces the metal material in terms of moldability and high degrees of freedom of formability, and use of resin materials such as polypropylene and polyvinylidene fluoride has been studied.

However, when using only a resin material, the resulting product may be warped or deformed, or may exhibit insufficient heat resistance and rigidity depending on the use environment.

In order to obtain a resin composition exhibiting high strength and high rigidity, attempts have been made to mix filler materials such as inorganic fillers (e.g. talc, mica, glass fibers, and calcium carbonate) into the resin. However, since these filler materials are inorganic powders produced by milling minerals, dissolution of metal ions easily occurs. Thus these filter materials are not satisfactory.

Moreover, since the inorganic filler has a high specific gravity, the weight of the resulting product is increased when aiming at achieving the target strength and rigidity. In addition, the inorganic filler may remain after combustion to damage a combustion furnace. Therefore, an improvement in recyclability is necessary.

In order to reduce the weight of the product and the amount of combustion residues while maintaining high strength and high rigidity, carbon fibers may be used as the filler. However, when reinforcing the resin composition using only carbon fibers, the molded product is warped or deformed due to orientation caused by the flow of the resin during injection molding.
[Patent document 1] JP-A-2001-035519
[Patent document 2] JP-A-2003-123804

An object of the invention is to provide a fuel cell member-forming resin composition and a fuel cell member which achieve reduced warping and low specific gravity while maintaining high strength and high rigidity, allow only a small amount of ions to dissolve, and produce only a small amount of combustion residues to facilitate heat recovery (thermal recycle) during combustion.

### DISCLOSURE OF THE INVENTION

The inventors of the invention have conducted extensive studies and found that the above object can be achieved by using specific carbon fibers and graphite powder for a resin composition including carbon fibers and graphite powder. This finding has led to the completion of the invention.

According to the invention, the following fuel cell member-forming resin compositions and the like are provided.
1. A fuel cell member-forming resin composition comprising:

(1) 67 to 89 wt % of a polypropylene-based resin;

(2) 1 to 3 wt % of an acid-modified polypropylene-based resin; and

(3) 10 to 30 wt % of carbon fibers and a high-purity ultrathin graphite powder having an ash content of less than 0.5 wt %.
2. A fuel cell member-forming resin composition comprising:

(i) 67 to 89 wt % of a polypropylene-based resin having a melt flow rate (temperature: 230° C., load: 2.16 kg) of 5 to 70 g/10 min;

(ii) 1 to 3 wt % of an acid-modified polypropylene-based resin; and

(iii) 10 to 30 wt % of carbon fibers having a diameter (D1) of 5 μm≦D1≦10 μm and a graphite powder having an ash content of less than 0.5 wt %, an average particle diameter (D2) of 5 μm≦D2≦15 μm, and an apparent density (ρ) of 0.02 g/cm³≦ρ≦0.10 g/cm³.
3. The fuel cell member-forming resin composition according to 1 or 2, having a conductivity of 2 μS/cm or less.
4. The fuel cell member-forming resin composition according to any one of 1 to 3, wherein the fuel cell member is a fuel cell cooling circuit part, a fuel cell ion-exchange part, or a fuel cell ion-exchange cartridge.
5. The fuel cell member-forming resin composition according to any one of 1 to 4, having a flexural strength and a flexural modulus measured in accordance with JIS K7171 of 80 MPa or more and 3800 MPa or more, respectively, and a content of combustion residues originating in the carbon fibers and the graphite powder measured in a combustion residue measurement test of 3% or less.
6. A fuel cell member comprising the resin composition according to any one of 1 to 5.

According to the invention, a fuel cell member-forming resin composition and a fuel cell member can be provided which maintain reduced warping and specific gravity, exhibit high strength, high rigidity, and low dissolution properties, and facilitate thermal recycle.

### BEST MODE FOR CARRYING OUT THE INVENTION

A fuel cell member-forming resin composition according to the invention comprises (1) 67 to 89 wt % of a polypropylene-based resin, (2) 1 to 3 wt % of an acid-modified polypropylene-based resin, and (3) 10 to 30 wt % of carbon fibers and a high-purity ultrathin graphite powder having an ash content of less than 0.5 wt %.

Another fuel cell member-forming resin composition according to the invention comprises (i) 67 to 89 wt % of a polypropylene-based resin having a melt flow rate (temperature: 230° C., load: 2.16 kg) of 5 to 70 g/10 min, (ii) 1 to 3 wt % of an acid-modified polypropylene-based resin, and (iii) 10 to 30 wt % of carbon fibers having a diameter (Dl) of 5 μm<D1<10 μm and a graphite powder having an ash content of less than 0.5 wt %, an average particle diameter (D2) of 5 μm≦D2≦15 μm, and an apparent density (ρ) of 0.02 g/cm³≦ρ≦0.10 g/cm³.

Each component of the composition according to the invention is described below.

1. Polypropylene-Based Resin

In the composition according to the invention, the polypropylene-based resin is a matrix resin. The polypropylene-based resin may be a homopolymer, a block copolymer, or a mixture thereof. As specific examples of the polypropylene-based resin, a propylene homopolymer, an ethylene-propylene block copolymer, and the like can be given.

The polypropylene-based resin used in the composition according to the invention has a melt flow rate (MFR) (temperature: 230° C., load: 2.16 kg, measured in accordance with JIS K7210) of preferably 5 to 70 g/10 min, and more preferably 20 to 70 g/10 min. If the MFR is less than 20 g/10 min, molding may become difficult. If the MFR exceeds 70 g/10 min, impact strength may be decreased.

A commercially-available product may be used as the polypropylene-based resin. As specific examples of the commercially-available polypropylene-based resin, J-2003GP (manufactured by Idemitsu Kosan Co., Ltd., MFR=20 g/10 min), J-3000GP (manufactured by Idemitsu Kosan Co., Ltd., MFR=30 g/10 min), Y-6005GM (manufactured by Idemitsu Kosan Co., Ltd., MFR=60 g/10 min), J-6083HP (manufactured by Idemitsu Kosan Co., Ltd., MFR=60 g/10 min), J-3054MP (manufactured by Idemitsu Kosan Co., Ltd., MFR=30 g/10 min), and the like can be given.

The amount of the polypropylene-based resin used in the composition according to the invention is 67 to 89 wt %, and preferably 77 to 89 wt %. If the amount of the polypropylene-based resin is less than 67 wt %, moldability deteriorates. If the amount of the polypropylene-based resin exceeds 89 wt %, rigidity and heat resistance become insufficient.

2. Acid-Modified Polypropylene-Based Resin

The interfacial strength between the polypropylene-based resin and the carbon fibers can be improved by adding the acid-modified polypropylene-based resin to the composition according to the invention.

The polypropylene-based resin used for the acid-modified polypropylene-based resin is the same as the above polypropylene-based resin. As examples of the acid group of the acid-modified polypropylene-based resin, carboxylic acids such as a maleic acid group, a fumaric acid group, and an acrylic acid group can be given. Of these, a maleic acid group is preferable. The amount of acid added is usually about 0.1 to 10 wt %.

A commercially-available product may be used as the acid-modified polypropylene-based resin. As specific examples of the commercially-available acid-modified polypropylene-based resin, Polybond 3200 and polybond 3150 (maleic acid-modified polypropylene manufactured by Shiraishi CalciumKaisha, Ltd.), Umex 1001, Umex 1010, Umex 1003, and Umex 1008 (maleic acid-modified polypropylene manufactured by Sanyo Chemical Industries, Ltd.), Admer QE800 and Admer QE810 (maleic acid-modified polypropylene manufactured by Mitsui Chemicals Inc.), Toyo Tac H-1000P (maleic acid-modified polypropylene manufactured by Toyo Kasei Kogyo Co., Ltd.), and the like can be given.

The amount of the acid-modified polypropylene-based resin used in the composition according to the invention is 1 to 3 wt %. If the amount of the acid-modified polypropylene-based resin is less than 1 wt %, flexural strength and heat resistance (thermal deformation temperature) are decreased. If the amount of the acid-modified polypropylene-based resin exceeds 3 wt %, production cost is increased to an impractical level.

3. Carbon Fibers

The carbon fibers provide the composition according to the invention with high rigidity to reinforce a molded product produced from the composition. The carbon fibers are also necessary to allow the composition according to the invention to have a low density and a low ash content.

The type of carbon fibers used in the composition according to the invention is not particularly limited. Any of PAN-based (HT, IM, HM) carbon fibers, pitch-based (GP, HM) carbon fibers, and rayon-based carbon fibers may be used. Of these, PAN-based carbon fibers are preferable.

The carbon fibers used in the composition according to the invention preferably have a diameter (D1) of 5 μm<D1<10 μm. If the diameter is 5 μm or less, the fibers may easily break, whereby strength may be decreased. Moreover, the cost of industrial production may be increased to an impractical level. If the diameter is 10 μm or more, the aspect ratio of the fibers may be decreased, whereby cost may be increased to an impractical level.

The diameter of the carbon fiber may be measured using an electron microscope.

As the method of producing carbon fibers having a diameter within the above range, methods disclosed in JP-A-2004-11030, JP-A-2001-214334, JP-A-5-261792, “New Introduction to Carbon Material” (edited by The Carbon Society of Japan, published by Realize Advanced Technology Limited, 1996), and the like can be given.

As the carbon fibers, carbon fibers having the above-mentioned diameter may be used without specific limitations. A commercially-available product may be used as the carbon fibers. As specific examples of the commercially-available carbon fibers, Besfight (registered trademark) chopped fibers HTA-C6-S, HTA-C6-SR, HTA-C6-SRS, HTA-C6-N, HTA-C6-NR, HTA-C6-NRS, HTA-C6-US, HTA-C6-UEL1, HTA-C6-UH, HTA-C6-OW, HTA-C6-E, MC HTA-C6-US; Besfight (registered trademark) filament HTA-W05K, HTA-W1K, HTA-3K, HTA-6K, HTA-12K, HTA-24K, UT500-6K, UT500-12K, UT-500-24K, UT800-24K, IM400-3K, IM400-6K, IM400-12K, IM600-6K, IM600-12K, IM600-24K, LM16-12K, HM35-12K, TM35-6K, UM40-12K, UM40-24K, UM46-12K, UM55-12K, UM63-12K, UM68-12K (the above products are manufactured by Toho Tenax Co., Ltd.); Pyrofil (registered trademark) chopped fibers TR066, TR066A, TR068, TR06U, TR06NE, TR06G (manufactured by Mitsubishi Rayon Co., Ltd.); Torayca chopped fibers T008A-003 and T010-003 (manufactured by Toray Industries Inc.); and the like can be given.

It is preferable to use carbon fibers provided with surface treatment (particularly electrolysis treatment). As examples of surface treatment agents, an epoxy-based sizing agent, a urethane-based sizing agent, a nylon-based sizing agent, an olefin-based sizing agent, and the like can be given. The tensile strength and the flexural strength of the molded product are improved by surface treatment. A commercially-available product may be used as the surface-treated carbon fibers. As specific examples of the commercially-available surface-treated carbon fibers, Besfight (registered trademark) chopped fibers HTA-C6-SRS, HTA-C6-S, HTA-C6-SR, HTA-C6-E (treated with epoxy-based sizing agent), HTA-C6-N, HTA-C6-NR, HTA-C6-NRS (treated with nylon-based sizing agent), HTA-C6-US, HTA-C6-UEL1, HTA-C6-UH, MC HTA-C6-US (treated with urethane-based sizing agent) (manufactured by Toho Tenax Co., Ltd.); Pyrofil (registered trademark) chopped fibers TR066, TR066A (treated with epoxy-based sizing agent), TR068 (treated with epoxy urethane-based sizing agent), TR06U (treated with urethane-based sizing agent), TR06NE (treated with polyamide sizing agent), TR06G (water-soluble sized) (manufactured by Mitsubishi Rayon Co., Ltd.); and the like can be given.

4. Graphite Powder

The graphite powder used in the composition according to the invention is a component having a function of preventing warping/deformation of a molded product produced from the composition according to the invention and preventing dissolution of ions.

As the graphite powder used in the composition according to the invention, high-purity ultrathin graphite is preferable.

The high-purity ultrathin graphite is produced by reducing the thickness and increasing the purity by physical refining and chemical treatment which remove impurities from graphite in addition to generally-employed steps, for example. The high-purity ultrathin graphite usually has an ash content of less than 0.5 wt %, an average particle diameter of 10 μm or less, and an apparent density of 0.1 g/cm³ or less.

The graphite powder used in the composition according to the invention has an ash content of preferably less than 0.5 wt %, and more preferably less than 0.3 wt %. The ash content is usually less than 0.5 wt % and 0.01 wt % or more. If the ash content is 0.5 wt % or more, the amount of ions dissolved may be increased, whereby the conductivity may exceed 2 μS/cm. The ash content of the graphite powder is determined by completely combusting 1 g of a graphite sample in an ash-combustion electric furnace maintained at 850 to 900° C., measuring the weight of the residual sample, and calculating the ash content.

The graphite powder used in the composition according to the invention preferably has an average particle diameter (D2) of 5 μm≦D2≦15 μm. If the average particle diameter of the graphite powder is less than 5 μm, a sufficient effect of preventing warping/deformation of a molded product obtained from the composition including such a graphite powder may not be obtained. If the average particle diameter of the graphite powder exceeds 15 μm, impact strength may be easily decreased. The average particle diameter of the graphite powder is measured using a laser diffraction scattering method in accordance with JIS R1629.

The graphite powder has an apparent density (ρ) of 0.02 g/cm³≦ρ≦0.1 g/cm³. If the apparent density of the graphite powder is less than 0.02 g/cm³, a sufficient effect of preventing warping/deformation of a molded product obtained from the composition including such a graphite powder may not be obtained. If the apparent density of the graphite powder exceeds 0.1 g/cm³, impact strength may be easily decreased. The apparent density of the graphite powder is measured using a still-standing method in accordance with JIS K5101.

A commercially-available product may be used as the graphite powder. As specific examples of the commercially-available graphite powder, UP-10 (manufactured by Nippon Graphite Industries, Ltd.) and the like can be given.

The total amount of the carbon fibers and the graphite powder used in the composition according to the invention is 10 to 30 wt %, and preferably 10 to 20 wt %. If the total amount of the carbon fibers and the graphite powder is less than 10 wt %, an effect of reducing warping may not be obtained. If the total amount of the carbon fibers and the graphite powder exceeds 30 wt %, the density (weight) of the composition or a molded product produced from the composition is increased, whereby the advantage (i.e. low density) obtained by using the carbon fibers is impaired.

The ratio of the carbon fibers and the high-purity ultrathin graphite powder included in the composition according to the invention is preferably 1:4 to 4:1, and more preferably 1:3 to 1:1.

The conductivity of the fuel cell member-forming resin composition according to the invention is preferably 2 μS/cm or less.

The flexural strength and the flexural modulus of a molded product produced from the composition according to the invention measured in accordance with JIS K7171 are preferably 80 MPa or more and 3800 MPa or more, respectively.

The content of combustion residues originating in the carbon fibers and the graphite powder contained in a molded product produced from the composition according to the invention, measured in a combustion residue measurement test, is preferably 3% or less.

The composition according to the invention may be. usually produced as follows.

Specifically, the composition may be produced by mixing (dry-blending) the raw materials and melt-mixing the mixture using an extruder. As the extruder, a known extruder such as a single-screw extruder or a twin-screw extruder may be used. The carbon fibers may be supplied together with other raw materials, or may separately supplied through a side feed. Methods disclosed in JP-A-62-60625, JP-A-10-264152, WO97/19805, and the like may also be used.

The composition according to the invention may include various additives in addition to the above components insofar as the object of the invention is not impaired. As examples of the additives which may be added, a coloring agent, an antioxidant, a metal deactivator, carbon black, a nucleating agent, a release agent, a lubricant, an antistatic agent, and the like can be given.

The resin composition according to the invention may be suitably used as the raw material for a fuel cell member. As examples of the fuel cell member, cooling circuit parts, fuel cell ion-exchange parts, fuel cell ion-exchange cartridges, and the like can be given.

A fuel cell member produced from the resin composition according to the invention has a low specific gravity, sufficient strength, and dimensional stability, and allows only a small amount of ions to dissolve. Since the carbon fibers and the graphite powder are used as the filler, combustion residues are produced to only a small extent, whereby the fuel cell member exhibits excellent thermal recyclability (excellent thermal energy recovery during combustion).

### EXAMPLES

The components used in the compositions of the example and comparative examples are as follows.
1. Polypropylene-Based Resin
Polypropylene (PP): J-3000GP (manufactured by Idemitsu Kosan Co., Ltd., MFR=30 g/10 min)
2. Acid-Modified Polypropylene-Based Resin
Maleic acid-modified polypropylene (MAH-PP): Polybond 3200 (manufactured by Shiraishi Calcium Kaisha, Ltd.)
3. Carbon Fibers
Carbon fibers: HTA-C6-SRS (manufactured by Toho Tenax Co., Ltd., diameter: 7 μm, treated with epoxy-based sizing agent)
4. Graphite Powder
UP-10 (artificial graphite powder manufactured by Nippon Graphite Industries, Ltd., ash content: 0.19 wt % or less, average particle diameter: 10 μm, apparent density: 0.04)
J-CPB (artificial graphite powder manufactured by Nippon Graphite Industries, Ltd., ash content: 2.0 wt % or less and 0.5 wt % or more, average particle diameter: 5 μm, apparent density: 0.09)
5. Others
Talc: JM209 (manufactured by Asada Milling Co., Ltd., average particle diameter: 4.5 μm)

The methods of measuring the properties of the compositions of the example and comparative examples are as follows.
1. Particle Diameter

The particle diameter was measured using a laser diffraction scattering method in accordance with JIS R1629.
2. Apparent Density

The apparent density was measured using a still-standing method in accordance with JIS K5101.
3. Flexural Strength

The composition obtained in the example or the comparative example was injection-molded to obtain a sample with dimensions of 80 mm×10 mm×4 mm.

The flexural strength of the sample was measured in accordance with JIS K7171.
4. Flexural Modulus

The flexural modulus of the flexural strength measurement sample was measured in accordance with JIS K7171.
5. Dissolution Properties (Conductivity)

The dissolution properties were measured according to the following procedure by indicating the amount of ions dissolved by conductivity.
(1) A sample (64 mm×12.7 mm×3.2 mm) was prepared for each example and comparative example.
(2) A 500 mL container made of PFA (fluororesin) was provided.
(3) The container was overfilled with pure water.
(4) The container was washed with pure water with shaking.
(5) The container was washed with ultrapure water with shaking.
(6) The container was dried.
(7) The container was washed with ultrapure water with shaking.
(8) The sample was cup-washed with ultrapure water.
(9) The sample was placed in the container.
(10) The container and the sample were washed with ultrapure water.
(11) Ultrapure water was supplied to the container until an UP level line was reached.
(12) The ultrapure water was stirred at 80° C. for 24 hours.
(13) After 10 hours, the container was removed from a thermostat bath and cooled to room temperature.
(14) A conductivity meter was checked.

A blank measurement without using a sample was carried out each time the sample set was changed for each example and comparative example.
6. Ash Content (Combustion Residues)

A pellet was produced from the composition obtained in the example or the comparative example using a melt-mixing method.

The ash content was measured using the resulting pellet according to the following procedure.
(1) The weight of a crucible was measured. This weight is referred to as W0.
(2) After placing the ash content measurement pellet in the crucible, the weight of the crucible was measured. This weight is referred to as W1.
(3) The crucible was placed in a muffle furnace, and the sample was subjected to ashing at 1000° C.
(4) After the completion of ashing, the crucible was removed from the instrument, and the weight of the crucible was measured. This weight is referred to as W2.
(5) The ash content was calculated by the following expression.
   Ash content (%)=(W2−W0) (weight after ashing)/(W1−W0) (weight before ashing)×100

The following instruments were used.
(1) Electronic balance: ER180A manufactured by Kensei Kogyo Co., Ltd.
(2) Muffle furnace: Muffle Furnace FP 310 manufactured by Yamato Scientific Co., Ltd.

### Example 1

83 wt % of polypropylene (PP) (J-2003GP), 2 wt % of maleic acid-modified polypropylene (MAH-PP) (Polybond 3200), 5 wt % of carbon fibers (HTA-C6-SRS), and 10 wt % of graphite powder (UP-10) were mixed to produce a composition.

The density, flexural strength, flexural modulus, dissolution properties, and ash content of the resulting composition were measured. The results are shown in Table 1.

### Comparative Example 1

60 wt % of polypropylene (J-2003GP) and 40 wt % of talc were mixed to produce a composition.

The resulting composition was evaluated in the same manner as in Example 1. The results are shown in Table 1.

### Comparative Example 2

A composition was produced and evaluated in the same manner as in Example 1 except for using J-CPB as the graphite powder. The results are shown in Table 1.

TABLE 1

| | | | Compar- | Compar- |
|---|---|---|---|---|
| | | | ative | ative |
| | | Example 1 | Example 1 | Example 2 |
| Polypropylene-based resin | | PP | PP | PP |
| Acid-modified polypropylene resin | | MAH-PP | — | MAH-PP |
| Carbon fibers | | HTA-C6- | Talc | HTA-C6- |
| | | SRS | | SRS |
| Graphite | Type | UP-10 | | J-CPB |
| powder | Particle diameter (μm) | 10 | 4.5 | 5 |
| | Apparent density (g/cm³) | 0.04 | — | 0.09 |
| | Ash content (wt %) | 0.19 or | — | 2.0 or |
| | | less | | less |

| | | | |
|---|---|---|---|
| Density (kg/m³) | 981 | 1230 | 981 |
| Flexural strength (MPa) | 94 | 48 | 93 |
| Flexural modulus (MPa) | 5500 | 4850 | 5230 |
| Conductivity (μS/cm) | 1.7 | 4.0 | 5.3 |
| Ash content | 3 | 40 | 3 |

It was found that the composition of Example 1 exhibited a low specific gravity, high strength, high rigidity, and low dissolution properties in comparison with the composition of Comparative Example 1 using talc generally used as a filler. In Comparative Example 2 using a general graphite powder with a low purity, the dissolution properties significantly deteriorate to a value below the fuel cell target value.

### INDUSTRIAL APPLICABILITY

The composition according to the invention may be used for a fuel cell member. In particular, the composition according to the invention may be suitably used for fuel cell cooling circuit parts, fuel cell ion-exchange parts, fuel cell ion-exchange cartridges, and the like.

1. A fuel cell member-forming resin composition comprising:
(1) 67 to 89 wt % of a polypropylene-based resin;
(2) 1 to 3 wt % of an acid-modified polypropylene-based resin; and
(3) 10 to 30 wt % of carbon fibers and a high-purity ultrathin graphite powder having an ash content of less than 0.5 wt %.

2. A fuel cell member-forming resin composition comprising:
(i) 67 to 89 wt % of a polypropylene-based resin having a melt flow rate (temperature: 230° C., load: 2.16 kg) of 5 to 70 g/10 min;
(ii) 1 to 3 wt % of an acid-modified polypropylene-based resin; and
(iii) 10 to 30 wt % of carbon fibers having a diameter (Dl) of 5 μm<D1<10 μm and a graphite powder having an ash content of less than 0.5 wt %, an average particle diameter (D2) of 5 μm≦D2≦15 μm, and an apparent density (ρ) of 0.02 g/cm³≦ρ≦0.10 g/cm³.

3. The fuel cell member-forming resin composition according to claim 1 or 2, having a conductivity of 2 μS/cm or less.

4. The fuel cell member-forming resin composition according to any one of claims 1 to 3, wherein the fuel cell member is a fuel cell cooling circuit part, a fuel cell ion-exchange part, or a fuel cell ion-exchange cartridge.

5. The fuel cell member-forming resin composition according to any one of claims 1 to 4, having a flexural strength and a flexural modulus measured in accordance with JIS K7171 of 80 MPa or more and 3800 MPa or more, respectively, and a content of combustion residues originating in the carbon fibers and the graphite powder measured in a combustion residue measurement test of 3% or less.

6. A fuel cell member comprising the resin composition according to any one of claims 1 to 5.
